(19) United States
(12) Patent Application Publication
(10) Pub. No.: US 2003/0196520 A1
(43) Pub. Date: Oct. 23, 2003

(54) Stripping device and a method for stripping

(76) Inventor: Beat Locher, Bierigutstrasse (CH)

Correspondence Address: M. Robert Kestenbaum, 11011 Bermuda Dunes NE, Albuquerque, NM, 87111, US

(21) Appl. No.: 10/445,983

(22) Filed: May 26, 2003

Related U.S. Application Data
(63) Continuation-in-part of application No. 09/647,693, filed on Dec. 19, 2000, now abandoned.
Application No. 09/647,693 is a 371 of international application No. PCT/IB99/00561, filed on Apr. 1, 1999.

(30) Foreign Application Priority Data
Apr. 6, 1998 (CH) 811/98
Dec. 24, 1998 (CH) 129/99

(51) Int. Cl. H02G 1/12

(52) U.S. Cl. 81/9.51

(57) ABSTRACT

A stripping device for multi-wire cables containing cable wires includes a clamping device, at least two non-rotatable blades acting against one another, at least two jaws that are adapted for displacement relative to one another toward the cable wires, and a drive for providing relative movement between the jaws and the cable wires along the cable wires. The relative-movement drive brings the cable wires into a single plane and parallel to each other.

This application is a Continuation-In-Part of U.S. patent application Ser. No. 09/647,693, filed Dec. 19, 2000 of the same inventor.

### CROSS-REFERENCES TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The invention relates to a stripping device, in particular for stripping multi-wire cables, having a clamping device and at least two non-rotatable blades acting relative to one another, and a method for stripping a multi-wire cable having at least two cable wires, each cable wire having at least one wire insulation and a common cable jacket.

### TECHNICAL FIELD

Multi-wire cables in the context of the invention are cables having at least 2, but preferably at least 3, wires having at least one wire insulation each and at least one second insulation—the cable sheath—in common around the insulated wires. Frequently, the insulated wires—the cable wires—are twisted inside the cable sheath.

The invention relates in particular to the stripping of such cables having twisted wires that should also be capable of being used in the case of cable wires that are not twisted.

Usually, such cables are stripped in two stages, by first removing the cable sheath by means of special sheath-stripping blades—e.g. radial V-blades—or by means of special rotating cable sheath blades and then removing the wire insulations around the wires—as a rule on a second machine—using special flat blades or shaped blades.

First, the insulated wires are oriented manually so that they come to rest side by side so that they can be cut into by means of a flat blade or by means of a flat shaped blade on both sides of the cable insulations, or a shaped blade is used which surrounds all twisted wires at once, partly cuts into their wire insulations and at the same time strips all insulations.

The first method is relatively labor-intensive and additionally requires relatively high investments since two stripping devices are required for a stripping process. Alternatively, the bared cable wires are also stripped individually using a second stripping device, by guiding said cable wires individually by hand in succession into the stripping device, which in turn involves a great deal of manipulation.

The second known method regularly results in poorly defined tear-off lines at the cuts in the wire insulation. Cutting in at only one point is frequently not sufficient for actually separating the relevant insulation section, so that waste can frequently occur. However, in this method—using a corresponding shaped blade—sheath and wire insulation can theoretically be removed simultaneously.

### SUMMARY OF THE INVENTION

It is the object of the invention to provide a device and a method with which the precision of the stripping is increased without substantially more complicated apparatus. Manual work required to date is to be dispensed with.

This object is achieved by a device comprising a drive for providing relative movement between the jaws and the cable wires along the cable wires, whereby the relative-movement drive brings the cable wires into a single plane and parallel to each other, and by a method comprising the following steps: removing the cable jacket, cutting into and stripping the wire insulation by non-rotatable blades, and before incision by the blades, orienting the cable wires parallel to one another by a component adapted for light touching movement on the cable wires, so that the cable wires are oriented in a plane parallel to cutting edges of the blades during a relative-movement between the wires and the jaws or blades along the cable axis.

The stripping device according to the invention for multi-wire cables satisfactorily achieves the object set in that it permits a relative movement of the cable between a clamping device and at least two nonrotatable blades acting against one another and/or at least two nonrotatable jaws acting against one another, the blades and/or the jaws being displaceable relative to one another, relative to the clamping device and in the direction toward the cable wires and, by means of a grazing movement, bringing the cable wires from their twisted or nonparallel position into a parallel position in a plane which is parallel to the cutting edges of the blades.

In the context of the invention, clamping device is to be understood as meaning all conventional devices between which a cable can be held in a fixed position for the purpose of processing by means of blades. These include in particular clamping jaws, transport rollers and conveyor belts or combinations thereof.

In the case of embodiments comprising clamping jaws, as a rule either these or the jaws or the blades or all of them are axially displaceable.

In the case of embodiments comprising transport rollers or conveyor belts, in principle both jaws and blades can remain stationary and as a rule only the cable is moved by rotating the rollers or belts.

Of course, this setup and this method also functions in the case of cables having cable wires which are not twisted but in which, during the stripping, it is not possible to predict how the cable wires are oriented inside the cable sheath.

A device according to the invention is expediently integrated in a stripping device comprising a corresponding cable sheath blade for the cable sheath but can also be accommodated in a separate housing so that it strips cable wires for which the sheath has already been removed.

According to the invention, the grazing movement can be performed by the blade as well as by separate jaws as well as by both together. What is important is that there is no premature incision by the blades.

In the case of the straightforward blade solution, these must be moved toward one another very carefully. Optionally, the blades can be spring-loaded relative to their blade holders, so that the cutting force is not applied until after the spring force has been overcome. Before this, only the force sufficient to move or displace the wires into a plane acts.

However, the solution with separate jaws that are arranged transversely to the cable wires and are preferably spring-loaded is preferred.

In one embodiment, these jaws are supported against the blades or are carried by them. This is most simply effected by a guide rail which guides one jaw each radially with respect to the cable axis, each jaw being supported under spring load with respect to its blade and the jaw surface facing the cable wires being present, in the rest state, closer to the cable wires than the cutting edge of the blade. This projection of the jaws reliably prevents premature incision by the blades.

The blades used are various, known blade shapes. The simplest is a flat blade but better quality is achieved using a shaped blade which has semicircular partial cutting edges which are shaped according to the thickness of the wire insulation and are located side by side and whose number corresponds at least to the number of cable wires which are to be stripped in this operation. For the purposes of the explanations in this patent application, the cutting edge of the blade also means an imaginary connecting line between such semicircular partial cutting edges.

The blades which are responsible for stripping the cable sheath may be individual or paired, rigid V-blades, radial blades, shaped blades as well as rotating blades. As is known per se, they are chosen according to the structure of the cable sheath. The detailed structure of such a device will not be discussed in this application since a large number of cable sheath stripping devices is known to those skilled in the art. Thus, for example, the Applicant brought a type JS 8300 onto the market, which operates with a rotating stripping blade. The present invention could be integrated, for example, in such a type.

Integration in a type CS 9500 of the Applicant (a continuous cable processing machine comprising drive rollers or drive belts before and after the processing tools) is likewise advantageous.

According to the invention, the displacement of the blades or jaws relative to the clamping device along the cable wires is quite likely also to include an operation in which the blades and jaws are axially rigid relative to the cable wires and the clamping device executes an axial relative displacement with or for the cable wires before the blades cut in. In each case, it is preferable that at least one blade cutting edge is arranged on that side of the cable which is closer to the adjacent cable end and at least one jaw is arranged on the side facing the cable origin. As a result, the grazing process has a longer-lasting effect on the position of the cable wires before the incision. Of course, the invention also includes the operation in which the cable itself is moved relative to the jaws or blades—in particular by rotary driving of transport rollers or conveyor belts which also perform clamping functions.

For better comprehension, reference is made to the cable or the cable wires in the claims. However, the invention is not limited to the presence of a cable.

Compared with a known setup comprising rotating blades and centering jaws which are supported in a spring-loaded manner relative to the blades, the invention differs primarily in that the blades for the cable wire are nonrotating and that, according to the invention, a grazing movement is provided which neither is provided nor would be expedient in those known devices which serve for stripping coaxial cables.

### BRIEF DESCRIPTION OF THE DRAWINGS

The invention is explained in more detail by way of example with reference to a drawing.

The Figures are described in association with one another and overall. Identical reference numerals denote identical components and reference numerals with different indices denote components having a similar function.

FIG. 1 shows a multi-wire cable having twisted cable wires—a typical mains cable—during the stripping of the cable sheath;

FIG. 2 shows a view of an exemplary cable sheath blade—in this case a radial blade or radial V-blade;

FIG. 3 shows the next step in the stripping according to the invention: a jaw—in the form of a spring-loaded sliding piece—moves to the twisted cable wires of the cable;

FIG. 3a shows a pair of rollers that move the twisted cable wires;

FIG. 4 shows the next step, in which the cable wires are separated and oriented by a grazing movement of the sliding pieces;

FIG. 5 shows the plan view of the setup according to FIG. 4;

FIG. 6 shows a view of the jaws or sliding pieces;

FIG. 7 shows the next step of the incision by the blade into the first insulation over the cable wires;

FIG. 7a shows pairs of belts that move the twisted cable wires;

FIG. 8 shows the stripping of the first insulation of the cable wires;

FIG. 9 shows the plan view of the setup according to FIG. 8;

FIG. 10 shows a view of the shaped blade for stripping the cable wires;

FIG. 11 shows the view and the section through two cooperating blades with integrated spring-loaded jaws or sliding pieces;

FIG. 12 shows the section through a variant of the setup according to claim 11, with both jaws on one side of the blades.

### THE REFERENCE NUMERALS IN THE FIGURES HAVE THE FOLLOWING MEANINGS

1 Cable axis

2 Cable, in particular, means cable

2a Rollers

2b Drive belts

3a Cable comprising twisted cable wires

3b Cable comprising cable wires separated and oriented according to the invention

4 Blade for stripping the sheath—cable sheath blade

5 Sheath section

6 Jaw or spring-loaded sliding piece

7 Blade for stripping the cable wires

8 Cable wire

9 Insulation sections

10 Blade cutting edge

11 Spring

### DETAILED DESCRIPTION OF THE INVENTION

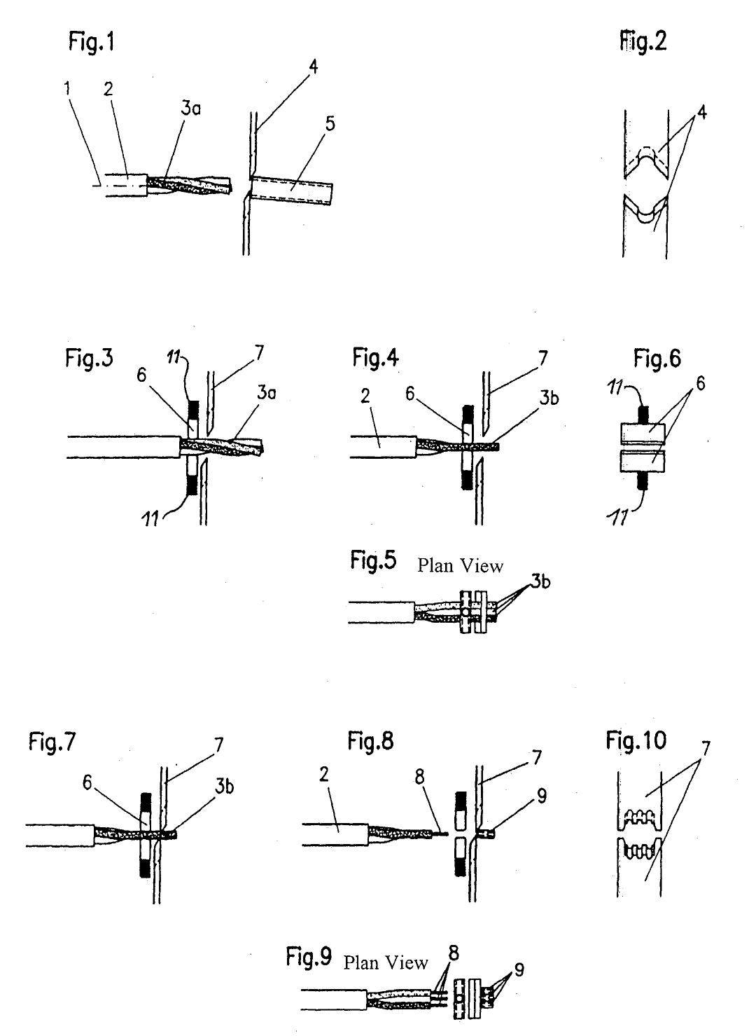

FIG. 1 shows a typical situation when stripping the sheath of a mains cable 2, in which two cable sheath blades 4 opposite one another cut into the sheath symmetrically with respect to the cable axis 1 and strip a sheath section 5. In the case of a prior art, the contours of the shaped blade 4 were chosen to be so narrow that parts of the insulation of the cable wires 3a were also removed simultaneously with the sheath—but without great precision, as mentioned above. According to the invention, the procedure is now limited to precise stripping of the sheath section 5 alone. Alternatively, rotating blades could also be used here.

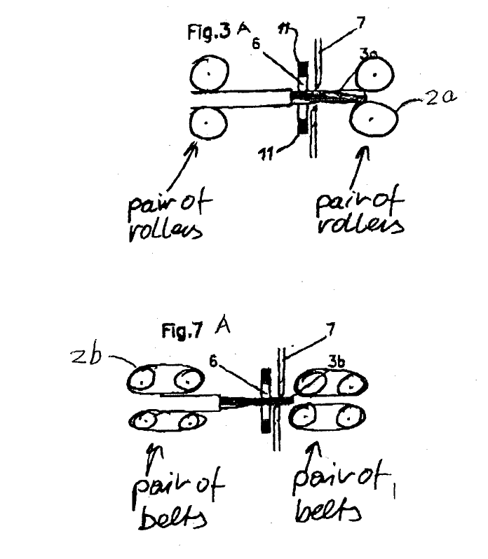

FIGS. 3-5 show the step, according to the invention, of separating the twisted cable wires 3a (FIG. 3) and orienting the cable wires into a parallel orientation 3b (FIG. 4). Here, it is not important whether the cable wires finally lie horizontally or in any other axial plane about the cable axis 1. What is critical is that this plane is related to the cutting edge of the blades 7, in particular, that this plane is parallel to the blade cutting edge. The separation and orientation are performed by a grazing (light touching) movement of the jaws against the cable wires in the form of sliding pieces 6 and the jaws and cable wires acting relative to one another.

This movement comprises a relative movement between the jaws and the cable toward the cable end and a movement of the jaws toward the cable wires. The latter is effected in particular by the force of one spring 11 each, which on the one hand acts on the sliding pieces 6 and on the other hand is supported on a spring holder, which is not shown. According to the invention, the spring holder is comparable with a conventional blade holder. Alternatively and preferably, the sliding pieces 6 are guided in a rail of the blade 7, and the spring 11 is supported against the blade 7. Pairs of rollers 2a, as shown in FIG. 3a, and pairs of drive belts 2b, as shown in FIG. 7a, are positioned before and after the blade 7 and the jaws 6, respectively. The blades constitute a cable stripping station.

FIGS. 7-9 show the procedure of cutting into and stripping the insulation sections 9 from the cable wires 8 for exposing the conductor.

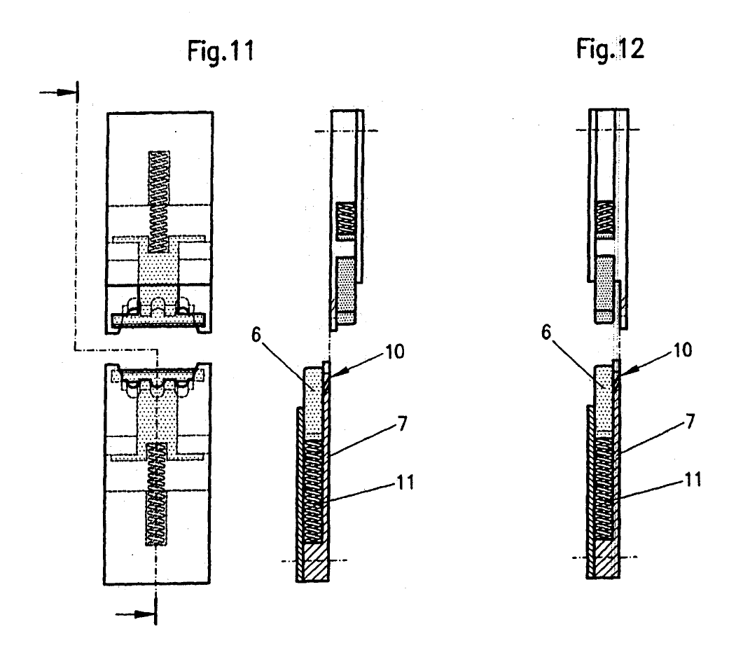

The projection of the sliding piece 6 beyond the blade cutting edge 10 in the rest state, i.e. before the cable wires are touched, is evident in the bottom right of FIG. 11. It is also evident that the sliding piece 6 is limited in movement with its foot against stops in the interior of the rail guide of the blade 7. The spring 11 which applies spring force to the sliding piece and which is likewise supported in the rail guide of the blade is also evident.

As a result of the geometry of the blades that should come into contact with one another in a shearing manner, the sliding pieces are not exactly opposite one another in this embodiment. In other embodiments, for example in which the jaws and the blades are separated or, for example, according to FIG. 12, they would preferably be present opposite one another.

I claim:

1. A stripping device for multi-wire cables (2), containing cable wires, comprising:
a clamping device,
at least two non-rotatable blades (7) acting against one another,
at least two jaws (6) that are adapted for displacement relative to one another in a direction toward the cable wires (8), and
a drive that provides relative movement between the jaws and the cable wires along the cable wires whereby the drive is arranged to bring the cable wires into a single plane and parallel to each other.

2. The stripping device as claimed in claim 1, wherein
the jaws (6) are spring-loaded toward the cable wires (8).

3. The stripping device as claimed in claim 1, wherein
the jaws (6) are supported by at least one of the blades (7) and blade-receiving blade holders.

4. The stripping device according to claim 1, wherein
each of the blades (7) comprises a guide rail that is adapted for guiding one of the two jaws (6) in a direction toward the cable wires.

5. The stripping device according to claim 1, wherein
the blades (7) comprise semi-circular partial cutting edges that are shaped according to a thickness of a wire insulation (9),
which semi-circular cutting edges are located side-by-side and the number of cutting edges correspond at least to a number of cable wires (8).

6. A method for stripping a multi-wire cable (2) having at least two cable wires (8), each cable wire having at least one wire insulation (9), and a common cable jacket (5),
comprising the following steps:
removing the cable jacket (5),
cutting into and stripping the wire insulation (9) with non-rotatable blades (7), and
before incision by the blades (7), orienting the cable wires (8) parallel to one another by a component adapted for a light touching movement on the cable wires, so that the cable wires are oriented in a plane parallel to cutting edges of the blades (7) during a relative-movement between the wires and at least one of the jaws and blades along the cable axis.

7. The method according to claim 6, wherein the cable wire orienting step further comprises the step of at least one of moving the jaws (6), the blades and the cable wires relative to each other to produce a light touching movement by displacing at least one of the blades (7) and the jaws (6) relative to the clamping device and along a cable axis.

8. The method according to claim 6, wherein the cable wire orienting step further comprises a simultaneous, slow and step-wise closing of at least one of the blades (7) and jaws (6) against the cable wires (8).

9. The method according to claim 6, further comprising the steps of:
displacing the jaws (6) relative to the clamping device and relative to one another and in a direction toward the cable wires (8), at least one of independently of and together with the blades (7), and
displacing the jaws (6) along the cable wires with simultaneous displacement relative to one another for applying the light touching movement.

10. The method according to claim 9, wherein the jaws are spring-loaded in a closing direction.

11. The method according to claim 9, wherein each jaw (6) is carried by a blade (7) and is supported in a spring-loaded manner relative to the blade (7), and wherein a jaw surface adapted to face the cable wires is in a rest state closer to the cable wires than the cutting edge of the blade (7).

12. The method according to claim 6, wherein the jaws (6) are held in a spring-loaded manner in a separate guide on a tool holder that carries at least one of a blade and a blade holder, with a spring force chosen so that the at least one wire insulation is not substantially deformed when lightly touched.

13. The method as claimed in claim 6, comprising the step of avoiding premature incision as the blades and jaws are closed against the cable wires (8).

14. A stripping device for a cable jacket (5) and multi-wire cables (2), comprising:
a clamping device,
at least two non-rotatable blades (7) acting against one another, and
at least two jaws (6) that are displaceable relative to one another,
wherein the clamping device comprises at least one of rollers and belts for transporting a cable relative to the blades (7) and jaws (6), and
wherein the jaws (6) are displaceable relative to the clamping device and the cable in order to lightly touch the cable wires (8) after removal of the cable jacket (5).

15. The stripping device according to claim 13, comprising:
drive that provides relative movement between the cable wires (8) and the jaws in an axial direction of the cable wires when lightly touching the cable wires.

16. The method according to claim 7, wherein the cable wire orienting step further comprises a simultaneous, slow and step-wise closing of the jaws (6) against the cable wires (8).

17. The method according to claim 6, wherein the cable wire orienting step further comprises the step of moving the jaws (6) relative to the cable wires to produce a light touching movement by displacing the jaws (6) relative to the clamping device and along a cable axis.

18. The method according to claim 6, wherein the jaws (6) are held in a spring-loaded manner in a separate guide on a tool holder that carries a blade holder, with a spring force chosen so that the wire insulations are not substantially deformed when lightly touched.

19. A stripping device for a cable jacket (5) and multi-wire cables (2), comprising:
a clamping device,
at least two non-rotatable blades (7) acting against one another, and
at least two jaws (6) that are displaceable relative to one another,
wherein the clamping device comprises belts for transporting a cable relative to the blades (7) and jaws (6), and
wherein the jaws (6) are displaceable relative to the clamping device and the cable in order to lightly touch the cable wires (8) after removal of the cable jacket (5).

20. The stripping device according to claim 14, comprising:
a drive for relative movement between the cable wires (8) and the jaws in an axial direction of the cable wires when lightly touching the cable wires.

21. A continuous cable stripping machine for multiple wire cables with at least one pair of rollers or pair of belts beside each side of a cable stripping station,
wherein jaws are mounted between one of said pairs and said stripping station,
said jaws are movable toward each other and slightly squeezing multiple wires of a cable, and
wherein during said squeezing said multiple wires are brought into one single plane, and
wherein said cables are movable along their axis by said pairs.
